(19) United States
(12) Patent Application Publication
(10) Pub. No.: US 2017/0155207 A1
(43) Pub. Date: Jun. 1, 2017

(54) ELECTRICAL CONNECTOR

(71) Applicant: Connec Limited, Rushcutters Bay, New South Wales (AU)

(72) Inventor: Stephen Williams, Rushcutters Bay, New South Wales (AU)

(21) Appl. No.: 15/320,737

(22) PCT Filed: Nov. 27, 2014
(86) PCT No.: PCT/AU2014/001083

§ 371 Date: Dec. 20, 2016

(30) Foreign Application Priority Data
Jul. 24, 2014 (AU) 2014902878

(51) Int. Cl. H01R 13/502; H01R 13/504; H01R 43/18; H01R 13/50

(52) U.S. Cl. CPC H01R 13/5025; H01R 13/50; H01R 13/504; H01R 43/18

(57) ABSTRACT

An electrical connection component for a machine cable and suitable for transmission of power with voltage levels greater than or equal to 1 kV, comprises a first electrical contact arranged for electrically coupling with a second contact and arranged for direct or indirect coupling to a conductor of the machine cable, also comprises a housing in which at least a portion of the first electrical contact is positioned. The housing has a body portion that is formed from a first polymeric material that has a first hardness. The housing also has a layer covering at least a portion of an outer surface of the body portion, the layer being formed from a second polymeric material that has a second hardness that is lower than the first hardness. The electrical connection component is arranged such that the layer reduces a transmission of an external impact force to the body portion.

### FIELD OF THE INVENTION

The present invention relates to an electrical connector used in high power applications. In particular the present invention relates to a connector suitable for using in demanding environments such as the petroleum or mining industry.

### BACKGROUND OF THE INVENTION

Reliable electrical connections are crucial in high power applications, such as powering of heavy electrical machinery often used in the mining or petroleum industry, or connection of power transportation lines. In these applications machine cables transmit high currents at voltages of one or more kilovolts.

Typical electrical connectors used in the art have a plurality of pins or sockets each connected to a respective core of the machine cable. Depending on the specific application, the connectors must comply with specific requirements or standards. The compliance of the connectors with the relevant standards is examined by a certifying body.

The certification of a connector for a specific application does generally ensure that the connector meets basic safety requirements. While known certified connectors are now relatively safe to operate, they still have a number of disadvantages.

Generally, high power connectors used in the mining or petroleum industry need to comply with strict load requirements and resistance to impacts and explosions requirements. However, because of these requirements the use of know connectors often have a design that makes their use cumbersome.

### SUMMARY OF THE INVENTION

Embodiments of the present invention aim to provide an electrical connector with a body which comprises a polymeric material and provides handling and manufacturing advantages.

In accordance with the first aspect, the present invention provides an electrical connection component for a machine cable, the electrical connection component being suitable for transmission of power with voltage levels greater than or equal to 1 kV and comprising:
a first electrical contact arranged for electrically coupling with a second contact and arranged for direct or indirect coupling to a conductor of the machine cable;
a housing in which at least a portion of the first electrical contact is positioned; the housing having a body portion that is formed from a first polymeric material that has a first hardness; and the housing having
a layer covering at least a portion of an outer surface of the body portion, the layer being formed from a second polymeric material that has a second hardness that is lower than the first hardness; wherein the electrical connection component is arranged such that the layer reduces a transmission of an external impact force to the body portion.

In an embodiment, the layer covers the entire outer surface of the body portion.

In an embodiment, the first polymeric material comprises a high density polymeric material. The second polymeric material may be ductile and may comprise a rubber or nylon material.

The layer may have a thickness between 1 mm and 50 mm or between 5 mm and 20 mm.

In an embodiment, at least one of the first and second polymeric materials is fibre or glass reinforced. The first polymeric material may be thermally or chemically treated to increase its hardness. The second polymeric material may be thermally or chemically treated to improve its impact absorption capacity.

In an embodiment, the body portion and the layer are formed in a manner such that the layer adheres to the body portion. At least a portion of the body portion and a portion of the layer may be integrally formed. The body portion and the layer may also be entirely integrally formed.

The body portion and the layer may be formed by co-moulding the first polymeric material and the second polymeric material. The layer may be entirely formed of the second polymeric material. The body portion may be entirely formed of the first polymeric material.

In an embodiment, the body portion comprises a plurality of body components, the plurality of body components comprising at least one first body component adapted to form fit into a second body component and to be positioned around the first contact whereby an internal volume of the body portion is at least partially filled with the components that comprise the first polymeric material.

The first body component may be removable and the housing and the first body component being arranged such that at least a portion of an internal region of the housing can be inspected when the first body component has been at least partially removed from the housing.

In an embodiment, the first polymeric material fills more than 70%, 80% or 90% of the internal volume of an internal portion of the body portion. The internal portion may fill more than 90%, 80% 70%, 60%, 50%, 40%, 30% or 20% of the internal volume of the body portion.

In an embodiment, the layer may surround the body portion. The layer may entirely cover a portion of the length of the body portion. In one embodiment the layer covers more than 60, 70, 80 or 90% of a surface of the body that is in use not covered by another component, such as a portion of another connection device.

In an embodiment, the body portion has a cylindrical shape and defines a cylindrical recess for hosting the first contact and the first polymeric material fills at least the majority of volume between the cylindrical recess and an outer peripheral wall of the body portion. The outer peripheral wall has a thickness between 5 mm and 50 mm. The body portion may have a cylindrical shape and defines a cylindrical recess for hosting the first contact and the first polymeric material fills a volume between the cylindrical recess and the peripheral wall in a manner such that the outer layer is supported against compressive forces and impact forces.

The body portion may be arranged to receive one or more components that fit in the volume between the cylindrical recess and the peripheral wall. The body portion may be also arranged to receive at least two components which form-fit into each other and into the volume between the cylindrical recess and the peripheral wall.

In one embodiment the electrical connection component comprises a plurality of electrically insulating components that are arranged such that they fit within the body portion in a predefined orientation or set of orientations. For example, a first electrically insulating component may be shaped so as to fit with a second electrically insulating component in a predefined orientation. For example, the first electrically insulating component may have a protrusion having a particular shape, with the second insulating component having a correspondingly shaped recess for receiving the protrusion of the first electrically shaped recess wherein, when the first insulating component is received in the second insulating component, the first and second insulating components have a predefined orientation with respect to one another.

Further, an electrically insulating component may be arranged so as to receive a plurality of other electrically insulating components, wherein at least one of the electrically insulating components surrounds at least a portion of the at least one conductor, an electrical conductor of the electrical connection component penetrating therethrough.

The electrically insulating components may comprise the same polymer materials as the body portion or may alternatively also comprise different polymeric materials.

In an embodiment, the component has a dimension which is comparable with steel based electrical connection components operating in a similar range or electrical power.

In an embodiment, the component is arranged to operate at a power rating greater than 50 kW

In accordance with a second aspect, the present invention provides a method of forming an electrical connection component for a machine cable in accordance with the first aspect.

In accordance with the third aspect, the present invention provides a method of forming an electrical connection component for a machine cable suitable for transmission of power with voltage levels greater than or equal to 1 kV, the method comprising the steps of:
co-moulding a first and second polymeric material to form a body portion and a layer, respectively, about at least a portion of the body portion, the first polymeric material of the body portion having a higher hardness than the second polymeric material of the layer, the body portion and the layer forming a part of a housing for incorporating at least a portion of a first contact arranged for electrically coupling with a second contact; and fitting the first contact to the body portion.

In an embodiment, the step of co-moulding a first and second polymeric material to form a body portion and a layer comprises surrounding the entire body portion with the layer.

In an embodiment, the step of co-moulding a first and a second polymeric materials comprises forming a plurality of body components, the plurality of body components comprising at least one first body component that form-fits into a second body component and is positioned around the first contact whereby an internal volume of the body portion is at least partially or largely filled with the components that comprise the first polymeric material.

In an embodiment, the method further comprises the step of fibre reinforcing at least one of the first or the second polymeric materials.

In an embodiment, the method further comprises the step of thermally treating the first polymeric material. The step of thermally treating the first polymeric material may comprise heating the material.

In an embodiment, the method further comprises the step of chemically treating the first polymeric material. The step of chemically treating the first polymeric material may comprise adding a chemical additive to the material to increase its hardness.

In an embodiment, the method further comprises the step of thermally treating the second polymeric material. The step of thermally treating the second polymeric material may comprise heating the material above a given temperature to improve its impact absorption properties.

In an embodiment, the method further comprises the step of chemically treating the second polymeric material. The first polymeric material may comprise adding a chemical additive to the material to improve its impact absorption properties.

In an embodiment, the method further comprises the step of co-moulding a first and a second polymeric material comprises:
forming the first material by injection moulding in a mould; and
forming the second material by injection co-moulding in the mould; and
cooling the first and the second materials injected in the mould.

In an embodiment, the method further comprises the step of co-moulding a first and a second polymeric material comprises:
simultaneously injecting the first and the second materials into the mould.

The invention will be more fully understood from the following description of specific embodiments of the invention. The description is provided with reference to the accompanying drawings.

### BRIEF DESCRIPTION OF THE DRAWINGS

FIG. 1 is an isometric view of the housing of a connector component in accordance with an embodiment;

FIG. 2 shows a cross-sectional view of a connector component in accordance with the embodiment;

FIG. 3 is an isometric view of a part of a connector component in accordance with the embodiment;

FIG. 4 is a flow-chart showing method steps for forming a connector component in accordance with the embodiment; and

FIG. 5 is a flow-chart showing method steps for forming an electrical connection component in accordance with an embodiment.

### DETAILED DESCRIPTION OF SPECIFIC EMBODIMENTS

Embodiments described herein provide an electrical connection component suitable for high power applications for connecting a machine cable. The connection component has a housing for hosting one or more electrical pins or sockets which can be connected to one or more cores of a machine cable. The housing of the connector has a polymeric body which can be manufactured by the injection moulding process. The polymeric construction of the housing of the connector component allows manufacturing lighter connectors.

The polymeric material of the polymeric body of the housing may have a first hardness and may comprise an outer layer that is formed form a second polymeric material that has a second hardness that is lower than that of the first polymeric material. The outer layer reduces the transmission of external impact forces to the body portion. In some embodiments the outer polymeric layer covers the entire outer surface of the body portion of the connector.

Embodiments of the present invention have significant advantages. The use of polymeric materials may result in a reduced weight compared with known connectors that are largely formed from metallic materials. Further, the use of a first polymeric material having a first (higher) hardness improves a mechanical strength of the housing and the use of a second polymeric material having the second (lower) hardness provides resilient properties for the connection component.

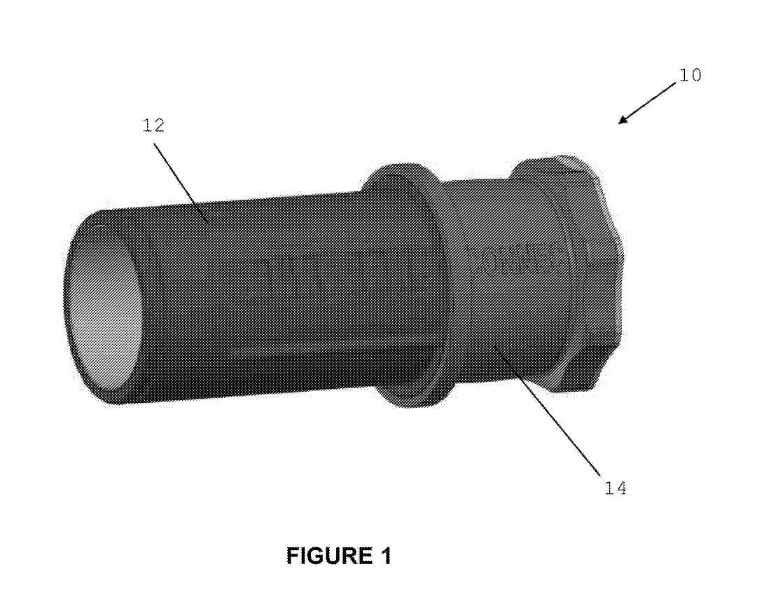

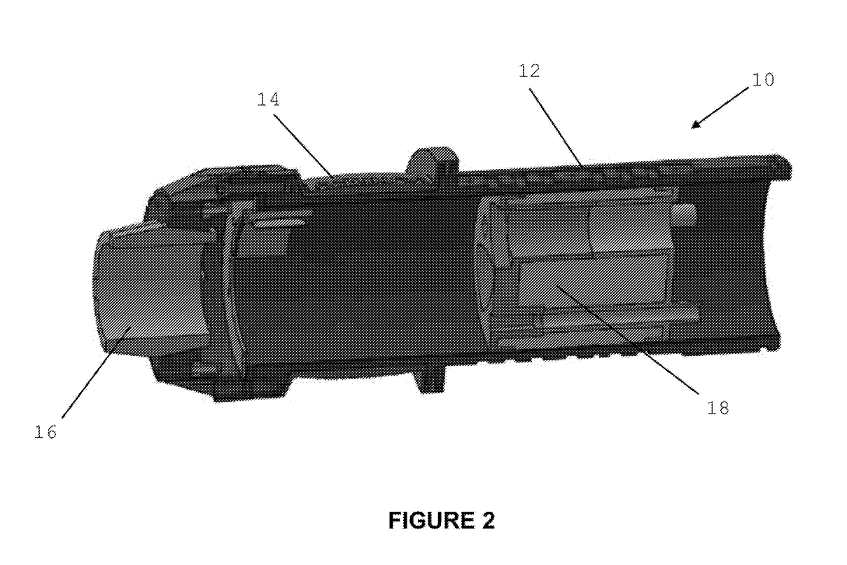

Referring initially to FIGS. 1 and 2, there is shown an electrical connection component 10 for a machine cable that is suitable for the transmission of power with voltage levels greater than or equal to 1 kV. The electrical connection component has a housing that is suitable to incorporate at least a portion of a first contact (not shown) arranged for electrically coupling with a second contact. The housing has a body portion that in this embodiment is provided by cylindrical body 12 that comprises a first polymeric material that has a first hardness and a layer 14 which covers a portion of cylindrical body 12. In this embodiment the body 12 is entirely made of the first polymeric material. The layer 14 comprises a second polymeric material with a second hardness which is lower than the hardness of the cylindrical body 12. The layer 14 allows reducing the transmission of an external impact force to the cylindrical body 12.

The polymeric material of the cylindrical body 12 is relatively hard so that the body 12 is capable of withstanding heavy loads and mechanical stresses that can occur in environments such as in mines, petroleum extraction sites or power plants. Depending on the location and the type of the site, specific requirements may be listed in operational standards.

Some portions of the cylindrical body 12 are covered by a layer 14 which comprises a softer polymer than the cylindrical body 12. In this embodiment, the entire layer 14 comprises the same polymeric material. The softer composition of the layer 14 improves impact and abrasion resistance of the cylindrical body 12. In some instances the hardness of the polymeric material of the body 12 may relate to brittleness and consequently the body portion 12 may be damageable by heavy impact loads. The layer 14 reduces likelihood of such damage.

In this embodiment, the body 12 comprises a polymeric material, for example a high density polymeric material or a hard rubber. Depending on the specific application and structural requirement, the body 12 may comprise one or more polymeric materials and may for example comprise a combination of the above-listed polymeric materials, which can also be fibre/glass reinforced.

In this embodiment, the layer 14 comprises fibre reinforced thermoplastic polyurethane (TPU). Depending on the application of the connector, the polymeric materials are thermally or chemically treatable to modify structural and mechanical properties. For example, the first polymeric material of the body 12 is thermally treated to increase its hardness by heating the material during the manufacturing process. Chemical additive can also be introduced to the polymeric materials of the body 12 and layer 14 to change their structural and mechanical properties.

The body portion 12 and the layer 14 are formed so that the layer adheres to the body portion. To improve manufacturing efficiency the body 12 and layer 14 formed by co-moulding the first polymeric material and the second polymeric material in the same mould.

Referring now to FIG. 2 there is shown a cross sectional view of the connector component 10. This figure shows additional components of the body 12, such as a cable clamping ring 16 and a contact module 18. These components may comprise the same polymer materials as the body 12 or may alternatively also comprise different polymeric materials. In this embodiment, the contact module 18 comprises a TPU shell and harder PU foam core.

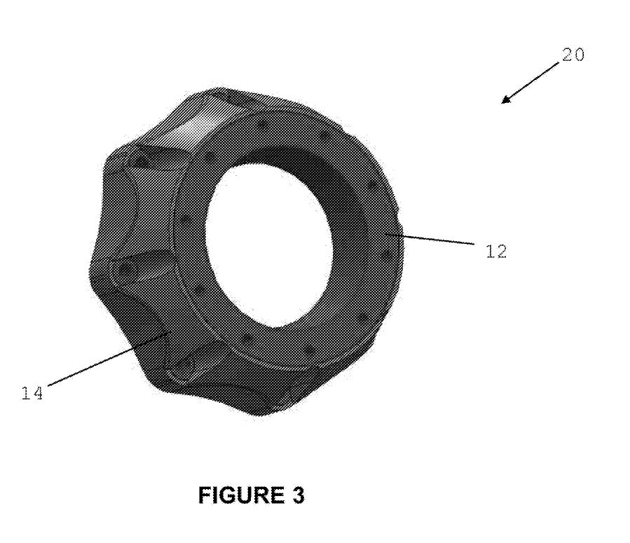

FIG. 3 shows a view of another component of the body 12, collar 20, which is entirely covered by the layer 14.

The different components of the body 12 are form-fitted into the main cylindrical shell of the body 12 and form-fitted to each other to partially fill the internal volume of the body 12 in order to improve the structural integrity and the resistance of the connector component.

In some embodiments the components fill the majority of a cylindrical volume portion within the cylindrical shell of the body portion 12. The cylindrical portion may fill more than 90%, 80% 70%, 60%, 50%, 40%, 30% or 20% of an internal space of the body portion 12 and may be designed to support the outer peripheral wall of the body portion to improve the impact resistance of the connector. In the embodiment, described the outer peripheral wall has a thickness of greater than 5 mm. Depending on the nature of the first polymer, in alternative embodiments the outer peripheral wall may have a thickness between 5 mm to 50 mm.

In one embodiment the electrical connection component 10 comprises a plurality of electrically insulating components that are arranged such that they fit within the body 12 in a predefined orientation or set of orientations. For example, a first electrically insulating component may be shaped so as to fit with a second electrically insulating component in a predefined orientation. For example, the first electrically insulating component may have a protrusion having a particular shape, with the second insulating component having a correspondingly shaped recess for receiving the protrusion of the first electrically shaped recess wherein, when the first insulating component is received in the second insulating component, the first and second insulating components have a predefined orientation with respect to one another.

Further, an electrically insulating component may be arranged so as to receive a plurality of other electrically insulating components, wherein at least one of the electrically insulating components surrounds at least a portion of the at least one conductor, an electrical conductor of the electrical connection component penetrating therethrough.

The electrically insulating components may comprise the same polymer materials as the body 12 or may alternatively also comprise different polymeric materials.

One of the electrically insulating components may be removable, the housing and the removable component being arranged such that at least a portion of an internal region of the housing can be inspected when the removable component has been at least partially removed from the housing.

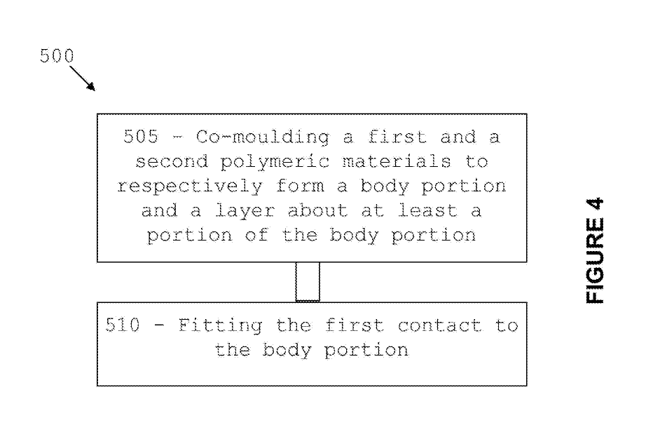

Referring now to FIG. 4, there is shown a flow chart 500 with method steps for forming an electrical connection component in accordance with an embodiment. The polymeric materials used to manufacture the component can be chemically treated, thermally treated or fibre reinforced, prior or during the moulding process. The two polymeric materials can be added into the moulding apparatus together and co-moulded (step 505) to form the body portion comprising the first polymeric material and a layer comprising the second polymeric material may be disposed on a portion or the entirety of the body portion. Additional parts of the body of the connector component can then be moulded and subsequently form-fitted together. Step 510 fits electrical contacts to the body portion.

In an alternative embodiment, the first and the second polymeric material can be formed in a moulding apparatus at different stages of the moulding process and respective temperature and/or chemical treatments may be applied to the two types of polymeric materials during the moulding process. The step of co-moulding the first and second polymeric material to form a body portion and a layer may be performed such that the entire body portion with the layer.

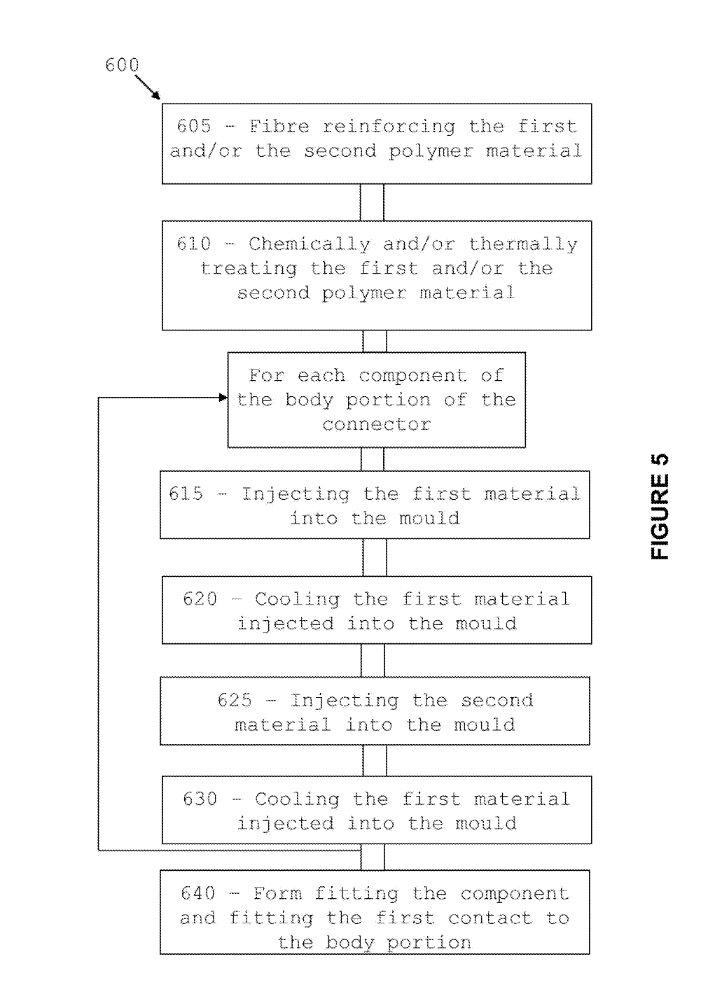

Referring now to FIG. 5 there is shown a further flow chart 600 with method steps for forming an electrical connection component in accordance with an embodiment. Step 605 fibre reinforces at least one of the first and second polymeric materials step 610 treats these materials chemically or thermally. The moulding process is performed for each component for each component of the body portion by injecting the polymer materials into a mould and cooling the materials (steps 615 to 630). The components of the body portions are then form-fitted together and the electrical contacts are placed into the component (step 640).

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. An electrical connection component for a machine cable, the electrical connection component being suitable for transmission of power with voltage levels greater than or equal to 1 kV and comprising:
a first electrical contact arranged for electrically coupling with a second contact and arranged for direct or indirect coupling to a conductor of the machine cable;
a housing in which at least a portion of the first electrical contact is positioned; the housing having a body portion that is formed from a first polymeric material that has a first hardness; and the housing having a layer covering at least a portion of an outer surface of the body portion, the layer being formed from a second polymeric material that has a second hardness that is lower than the first hardness; wherein the electrical connection component is arranged such that the layer reduces a transmission of an external impact force to the body portion.

2. The component of claim 1 wherein the layer covers the entire outer surface of the body portion.

3. The component of claim 1 wherein the first polymeric material comprises a high density polymeric material.

4. The component of claim 1 wherein the second polymeric material comprises a rubber or nylon material.

5. (canceled)

6. (canceled)

7. The component of claim 1 wherein at least one of the first and second polymeric materials are fibre or glass reinforced.

8. (canceled)

9. (canceled)

10. The component of claim 1 wherein the body portion and the layer are formed in a manner such that the layer adheres to the body portion.

11. The component of claim 1 wherein at least a portion of the body portion and a portion of the layer are integrally formed.

12. The component of claim 1 wherein the body portion and the layer are entirely integrally formed.

13. The component of claim 1 wherein the body portion and the layer are formed by co-moulding the first polymeric material and the second polymeric material.

14. (canceled)

15. (canceled)

16. The component of claim 1 wherein the body portion comprises a plurality of body components, the plurality of body components comprising at least one first body component adapted to form fit into a second body component and to be positioned around the first contact whereby an internal volume of the body portion is at least partially filled with the components that comprise the first polymeric material.

17. (canceled)

18. (canceled)

19. (canceled)

20. (canceled)

21. The component of claim 1 wherein the body portion has a cylindrical shape and defines a cylindrical recess for hosting the first contact and the first polymeric material fills at least the majority of volume between the cylindrical recess and an outer peripheral wall of the body portion.

22. (canceled)

23. The component of claim 1 wherein the body portion has a cylindrical shape and defines a cylindrical recess for hosting the first contact and the first polymeric material fills a volume between the cylindrical recess and the peripheral wall in a manner such that the outer layer is supported against compressive forces and impact forces.

24. The component of claim 22 wherein the body portion is arranged to receive one or more components which fit in the volume between the cylindrical recess and the peripheral wall.

25. The component of claim 24 wherein the body portion is arranged to receive at least two components which form-fit to each other and into the volume between the cylindrical recess and the peripheral wall.

26. The component of claim 1 wherein the component has a dimension which is comparable with steel based electrical connection components operating in a similar range or electrical power.

27. (canceled)

28. (canceled)

29. A method of forming an electrical connection component for a machine cable suitable for transmission of power with voltage levels greater than or equal to 1 kV, the method comprising the steps of:
co-moulding a first and second polymeric material to form a body portion and a layer, respectively, about at least a portion of the body portion, the first polymeric material of the body portion having a higher hardness than the second polymeric material of the layer, the body portion and the layer forming a part of a housing for incorporating at least a portion of a first contact arranged for electrically coupling with a second contact; and fitting the first contact to the body portion.

30. The method of claim 29 wherein the step of co-moulding a first and second polymeric material to form a body portion and a layer comprises surrounding the entire body portion with the layer.

31. The method of claim 29 wherein the first polymeric material comprises high density polymer and wherein the second polymeric material is a rubber or nylon material.

32. (canceled)

33. The method of claim 29 wherein the step of co-moulding a first and a second polymeric materials comprises forming a plurality of body components, the plurality of body components comprising at least one first body component that form-fits into a second body component and is positioned around the first contact whereby an internal volume of the body portion is at least partially or largely filled with the components that comprise the first polymeric material.

34. (canceled)

35. (canceled)

36. (canceled)

37. (canceled)

38. (canceled)

39. (canceled)

40. (canceled)

41. (canceled)

42. (canceled)

43. The method of claim 29 wherein the step of co-moulding a first and a second polymeric material comprises:
forming the first material by injection moulding in a mould; and
forming the second material by injection comoulding in the mould; and
cooling the first and the second materials injected in the mould.
